(19) United States
(12) Patent Application Publication
(10) Pub. No.: US 2009/0282027 A1
(43) Pub. Date: Nov. 12, 2009

(54) Distributional Similarity Based Method and System for Determining Topical Relatedness of Domain Names

(76) Inventors: Michael Subotin, Greenbelt, VA (US); Alan Sullivan, Leesburg, VA (US)

Correspondence Address: POTOMAC PATENT GROUP PLLC, P. O. BOX 270, FREDERICKSBURG, VA, 22404, US

(21) Appl. No.: 12/434,626

(22) Filed: May 2, 2009

Related U.S. Application Data
(60) Provisional application No. 61/192,942, filed on Sep. 23, 2008.

(51) Int. Cl. G06F 17/30

(52) U.S. Cl. 707/5; 707/E17.032; 707/E17.014; 707/102

(57) ABSTRACT

Systems, computer software and methods for calculating relatedness scores of domain names, which are indicative of relatedness of pairs of domain names requested by clients are described. The method includes receiving DNS traffic data, where the DNS traffic data includes at least domain names requested by the clients and identities of the clients requesting the domain names; generating, based on the identities of the clients, vectors including the requested domain names, where entries in the vectors correspond to client sessions in which the client has requested the domain names; reducing a dimensionality of the vectors by applying a dimensionality reduction method for generating reduced vectors; applying a similarity metric to the reduced vectors to calculate the relatedness scores; and storing the relatedness scores of the domain names.

### RELATED APPLICATION

This application is related to, and claims priority from, U.S. Provisional Patent Application Ser. No. 61/192,942, filed on Sep. 23, 2008, entitled “Method and System for Determining Topical Relatedness of Domain Names” to M. Subotin and A. Sullivan, the entire disclosure of which is incorporated here by reference.

### TECHNICAL FIELD

The present invention generally relates to systems, software and methods and, more particularly, to mechanisms and techniques for determining topical relatedness of domain names based on distributional similarity.

### BACKGROUND

During the past several years, interest in data available on the Internet and Internet services has dramatically increased, in part due to the affordability of access to the Internet and in part due to the ease of obtaining fast and reliable information. Moreover, Internet users have come to realize that the amount of data that is available on the Internet is phenomenal. Various search engines are available to aid Internet users to search for desired information. Conventional search engines (e.g., those provided by Yahoo, Google, etc.) provide the user with an input box into which the user must enter keywords related to the desired information. FIG. 1 illustrates such a conventional search process, e.g., with one or more keyword(s) being input in step 100. The keyword(s) may refer, for example, to a product that the user is interested in. The keyword(s) are received by the search engine in step 110. A component of the search engine determines, in step 120, which web sites or web pages are relevant to the keyword(s) which were entered by the user. This determination is made in part by matching the keyword(s) with the content of the web sites. More specifically, the keyword input(s) entered by the user is found in the information available on, or associated with, the web page such that the web page is determined to be relevant by the search engine. A ranked list of all of the web sites that were matched to the keyword(s) is provided, in step 130, to the user, e.g., as a list of links or the like.

With this approach pages from a domain are unlikely to be displayed to the user unless user's query includes its domain name or other words included in its content verbatim. In contrast, in many scenarios the user many be interested in finding web pages related to the content of a particular domain but not belonging to the domain itself. This may be the case, for example, when a user who knows one online store specializing in a particular area is looking to find other stores which sell similar products for purposes of price comparison.

Additionally, there is an opportunity to supply ads which are embedded into the information that a user is looking for, and the advertisement industry is repositioning itself to occupy this new advertising field. More and more ads are being placed on most of the web pages visited by Internet users with the expectation that some of the users will visit those ads and at least explore, if not buy, the goods or services featured in the ads. Various companies have started to specialize in tracking consumer/client behavior such that more targeted ads are placed on the visited web pages. It is known that it is not efficient to advertise goods or services on web pages that are not related to those goods or services.

Accordingly, it would be desirable to provide systems and methods for generating and updating information about relatedness of Internet domains and web pages.

### SUMMARY

According to one exemplary embodiment, there is a method for calculating relatedness scores of domain names, which are indicative of relatedness of pairs of domain names requested by clients. The method includes receiving DNS traffic data, wherein the DNS traffic data includes at least domain names requested by the clients and identities of the clients requesting the domain names; generating, based on the identities of the clients, vectors including the requested domain names, wherein entries in the vectors correspond to client sessions in which the client has requested the domain names; reducing a dimensionality of the vectors by applying a dimensionality reduction method for generating reduced vectors; applying a similarity metric to the reduced vectors to calculate the relatedness scores; and storing the relatedness scores of the domain names.

According to another exemplary embodiment, there is a server for calculating relatedness scores of domain names, which are indicative of relatedness of pairs of domain names requested by clients. The server includes an input/output interface configured to receive DNS traffic data, wherein the DNS traffic data includes at least domain names requested by the clients and identities of the clients requesting the domain names and a processor. The processor is connected to the input/output interface and is configured to generate, based on the identities of the clients, vectors including the requested domain names, wherein entries in the vectors correspond to client sessions in which the client has requested the domain names, reduce dimensionality of the vectors by applying a dimensionality reduction method for generating reduced vectors, and apply a similarity metric to the reduced vectors to calculate the relatedness scores. The server also includes a memory connected to the processor and configured to store the relatedness scores of the domain names.

According to still another exemplary embodiment, there is a computer readable medium including computer executable instructions, wherein the instructions, when executed, implement a method for calculating relatedness scores of domain names, which are indicative of relatedness of pairs of domain names requested by clients. The method includes providing a system comprising distinct software modules, wherein the distinct software modules comprise a DNS traffic module, a vector generating module, and a mathematical module; receiving DNS traffic data via the DNS traffic module, wherein the DNS traffic data includes at least domain names requested by the clients and identities of the clients requesting the domain names; generating in the vector generating module, based on the identities of the clients, vectors including the requested domain names, wherein entries in the vectors correspond to client sessions in which the client has requested the domain names; reducing in the mathematical module a dimensionality of the vectors by applying a dimensionality reduction method for generating reduced vectors; applying a similarity metric to the reduced vectors to calculate the relatedness scores; and storing the relatedness scores of the domain names.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram illustrating how a traditional search engine determines a web page to be presented to a user;

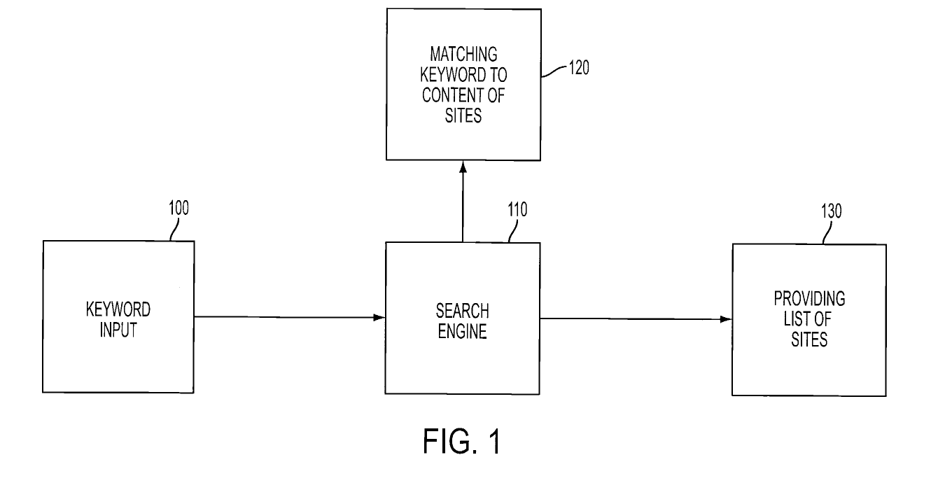

FIG. 2 is an exemplary screen shot that a client may use in a novel browser according to an exemplary embodiment;

FIG. 3 is an exemplary screen shot of the novel browser of FIG. 2;

FIG. 4 is a schematic diagram of a computer based system in which a client accesses the Internet via an Internet Service Provider;

FIG. 5 illustrates information received and stored at a Domain Name Server;

FIG. 6 illustrates vectors including domain names according to the client identity;

FIG. 7 illustrates a matrix W including domain names requested by clients according to an exemplary embodiment;

FIG. 8 illustrates applying a dimensionality reduction method to a matrix W according to an exemplary embodiment;

FIG. 9 illustrates a tree path of requested domain names according to an exemplary embodiment;

FIG. 10 is a schematic diagram of a computer based system in which a client accesses the Internet via an Internet Service Provider and an independent server may provide various services to the client according to an exemplary embodiment;

FIG. 11 illustrates an example of a tree path of three domain names and associated relatedness measures according to an exemplary embodiment;

FIG. 12 illustrates steps of a method for calculating a relatedness score for a pair of domain names according to an exemplary embodiment;

FIG. 13 illustrates steps of a method for calculating the relatedness score for a pair of domain names according to another exemplary embodiment;

FIG. 14 is a schematic diagram of the independent server shown in FIG. 10; and

FIG. 15 is a schematic diagram of specific modules implemented in a processor for performing the steps shown in FIGS. 12 and 13 according an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of Internet based systems having, among other things, DNS functionality. However, the embodiments to be discussed next are not limited to these systems but may be applied to other existing data systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

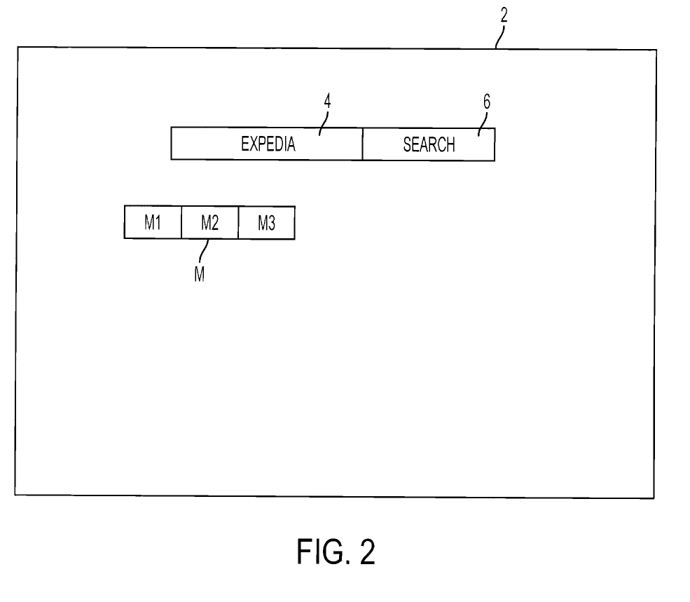

As discussed in the Background section, there is a need to develop new tools and search engines that are more accurate, faster, more reliable and more capable than the existing tools. According to an exemplary embodiment, a domain-query search engine that does not use only keywords to search for desired information is shown in FIG. 2. FIG. 2 shows a screen 2 that is presented to a user. On the screen 2, the user may see an empty box 4, in which the query may be entered. A button 6 provides the search functionality. A more sophisticated search engine according to other exemplary embodiments could be implemented as a graphical user interface or a browser with various buttons M, each button or control object being associated with a different algorithm for calculating the relatedness of domain names based on the user's input(s). Exemplary algorithms are described in detail below. This exemplary domain-query search engine accepts as an input not only keywords but also, or alternatively, a domain name of interest.

For example, as shown in FIG. 2, a user may enter the “Expedia” domain name, e.g., as “www.expedia.com”, as “expedia.com” or simply as “expedia.” Suppose that a user only knows about the Expedia web site as a site for booking an airplane, hotel, car, etc. However, if that user becomes dissatisfied, for example, with the prices quoted by this site, the user might want to search for similar sites that offer similar products or services, but maybe at a better price. Thus, according to an exemplary embodiment, the user searches for similar web sites or companies based on the relatedness of their domain names.

Based on, among other things, the concept that the collective wisdom is the best approach to follow, search engines or other applications according to these exemplary embodiments, calculate, as will be described later, a relatedness score between the input domain name or web site (e.g., “Expedia” in the example above) and other domain names or web sites. This relatedness score can, for example, be calculated based on captured data generated by various users while searching the Internet, for example, data generated in a Domain Name System (DNS) server. The DNS server, which is discussed in more detail later, is capable of storing the IP addresses of the users, the addresses of the user requested web pages, and the relationships between the users and web pages requested by those users. According to exemplary embodiments, those sites having the highest relatedness scores to the domain name(s) entered as input are then returned to the user in any desired format.

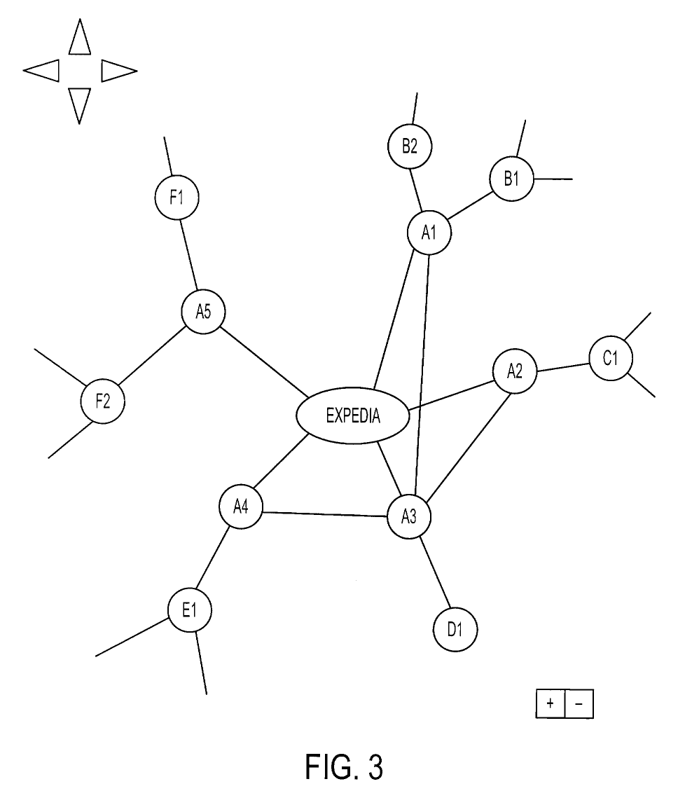

FIG. 3 shows an exemplary display screen that is provided to the user after the search is performed. This exemplary display of results could, for example, be a final output of results or could also represent an opportunity for the user to refine his or her search. In this display, an icon, text, image or marker representing the site Expedia may be positioned in the center of the figure and the topically related sites, which were identified by the relatedness search algorithm, are displayed around the main site Expedia. Links between the main site Expedia and the newly found (and related) sites may be displayed, for example, as a line that might have a length or thickness which is proportional with that site's relatedness score relative to “Expedia” (not shown). In another exemplary embodiment, the score between Expedia and the related sites is represented by displaying the links in different colors (not shown), e.g., red being highly related, yellow being somewhat related and green being less related than either red or yellow links. Other possibilities to visualize the relatedness score between the Expedia site and related sites may be used, as will be recognized by those skilled in the art.

FIG. 3 also shows that various buttons or other control objects may be provided in exemplary user interfaces which are used to provide the search results, such objects which enable the user to move to a site identified by the search by using arrows (see arrows in left upper corner of the figure) or using zoom in and out buttons (see buttons in right lower corner of the figure) to display fewer or more search results. Other buttons or control objects that streamline and simplify the navigation may be added, like for example a home button that brings the user to the initial domain name (e.g., Expedia). Alternatively, or additionally, a first button may be provided labeled “Keyword” and a second button labeled “Domain Name”. In such an embodiment, after the user enters an input into the text box on the interface, she or he can press either the “Keyword” button or the “Domain Name” button and the interface will process the search request either as a keyword search, e.g., using a conventional keyword search engine, or as a domain name search, e.g., using the techniques described below. The results can then be output using any of the aforedescribed user interface screens or other output mechanisms.

According to another exemplary embodiment, the user may navigate from one site to another site by rolling the cursor over a desired web site, which is displayed on the screen. By moving the cursor over any displayed web site, the graphical interface may, based on the calculated scores, display the links between the newly selected web site and the sites related to the selected web site. According to an exemplary embodiment, this action may reposition in the center the newly selected web site and move all the other web sites accordingly. Thus, a browsable graph may be generated on the screen as shown, for example, in FIG. 3. According to this exemplary embodiment, the user, after inputting/typing a keyword and/or a domain name, may browse other related web sites by simply using the mouse (or another point and click device) instead of typing more words, thus, simplifying the browsing process.

According to another exemplary embodiment, the graphical user interface may present the user with the information that a traditional search engine would present about a given web site, e.g., a list of hyperlinks with some text in a standard list format, albeit the websites themselves would be ordered based upon relatedness as described below. According to another exemplary embodiment, the graphical interface may present the user, when selecting a specific web site, only with those related web sites that are either geographically connected with the selected web site or with those related web sites that are temporally connected to the selected web site. For example, suppose that the user is interested to fix his flat tire and the user knows about a repair shop called FixFlatTire in his or her community. However, the user is not happy with the prices charged by FixFlatTire. Thus, the user may type, e.g., in the input box of the novel browser according to this exemplary embodiment, the domain name “FixFlatTire” and the browser could returns one or more places that may fix a flat tire, e.g., based upon the topical relatedness techniques described below, and which are also located in close geographic proximity to the FixFlatTire or to the location of the user, because the user is interested only in places that are close to his or her location, e.g., house, work place, etc. Close proximity in this sense may be defined in terms of miles or zip codes by the user prior to performing the search, e.g., by entering such information into the user interface prior to clicking the “Search” button or “Domain Name Search” button.

Regarding the temporal approach, suppose that a user intends to watch a movie around 8 pm during a certain day. The user is aware of a movie theater called BestMovie in her community. After the user enters the name of the movie theater, a browser according to these exemplary embodiments may present the user, based on the calculated relatedness scores and the desired time, with other movie theaters that offer a movie around the same time. Thus, the user is presented with a more focused search result than a traditional search engine.

According to another exemplary embodiment, a tool may be developed based on the calculated relatedness scores, and the tool presents a user with “Internet paths” followed by other users after visiting a certain domain name. For example, by knowing that many or most of Internet users that have visit the domain name “Hotels.com” after visiting the domain name “Expedia.com”, e.g., using one or more of the below described topical relatedness techniques, a company that, for certain reasons, wishes to advertise on Expedia, may decide to also advertise on Hotels as many or most of the users would be expected to transit from Expedia to Hotels. Thus, this tool may provide the user with a road map of “highways” that start from an initial domain name and continue to related domain names, such that the user may make an informed decision when selecting which domain names to target for his or her ads.

Other implementations of the relatedness score (to be described next) may be envisioned by those skilled in the art. However, a component of all such implementations is the ability to calculate the relatedness score of domain names based on the behavior of many users.

According to an exemplary embodiment, data related to client queries from DNS resolvers may be used to determine topical relatedness of various Internet domains with respect to contents of their web pages or other services they may provide to clients. This data may include information related to a time the user requested the domain time and to a physical location of the user. For that purpose, queries from DNS resolvers may be stored in dedicated files (logs) together with the IP address of the client (which may correspond to one or more clients) and the time of the request.

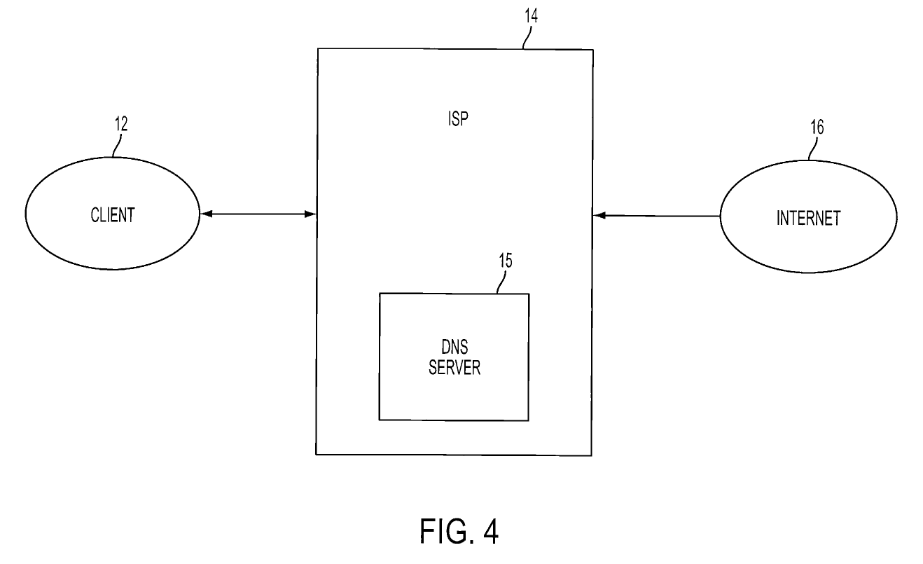

For example, as shown in FIG. 4, when a client 12 requests a certain page (each page belongs to a certain domain) from the Internet 16, the Internet service provider (ISP) 14 uses DNS services, which may be distributed over the Internet 16, or implemented in DNS server 15 within the ISP 14, to translate the domain name of the requested page to an IP address and then forwards the client's request to the appropriate domain, based on the stored IP address of the requested domain. One skilled in the art would appreciate that FIG. 4 may oversimplify the processes that are taking place and the number of nodes involved in an actual request to avoid obscuring the general concept. Additionally, it will be appreciated that the term “client” as used herein may refer to a person, an end user device (e.g., a personal computer, a personal digital assistant, a mobile phone, or the like), a browser application, or any combination thereof which sends web page requests.

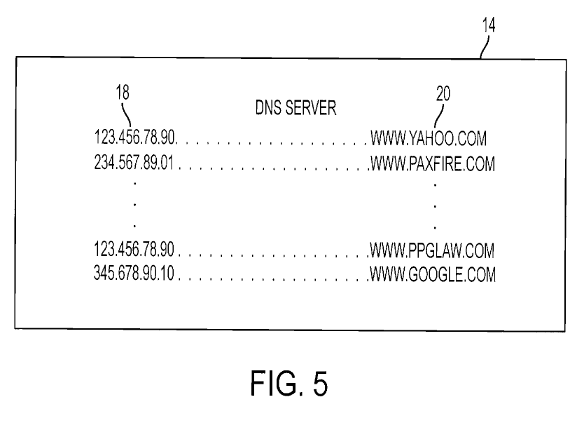

In this respect, FIG. 5 shows a table that, according to an exemplary embodiment, may be populated at an ISP (or, more precisely, on a DNS server of the ISP) and includes the IP addresses 18 of the users and the domain names 20 of the pages requested by the users. The DNS may also store a time stamp of each request (not shown) and a geographical location of the user (not shown). This information may be used for determining the topical relatedness of various Internet domains according to exemplary embodiments, as will be discussed below. It is noted that according to an exemplary embodiment, the table shown in FIG. 5 stores the IP addresses of the users together with the requested domain names in the order in which these requests are received at the DNS server.

As the security of the users is a concern for the ISP providers, one skilled in the art would appreciate that the IP addresses 18 should, preferably, not be disclosed to third parties, e.g., to protect against unauthorized tracking of the behavior of the individual users. Thus, according to an exemplary embodiment, the IP addresses of the clients are eventually discarded and only the domain names requested by the clients are used for determining the topical relatedness of the various Internet domains. The sequence of the requests and optionally, the times of the requests, may be part of the information that is used for determining the topical relatedness. However, it will be appreciated that the exemplary embodiments are not so limited and that, according to other exemplary embodiments, various information about individual clients and users could be retained and analyzed to provide personalized services to clients.

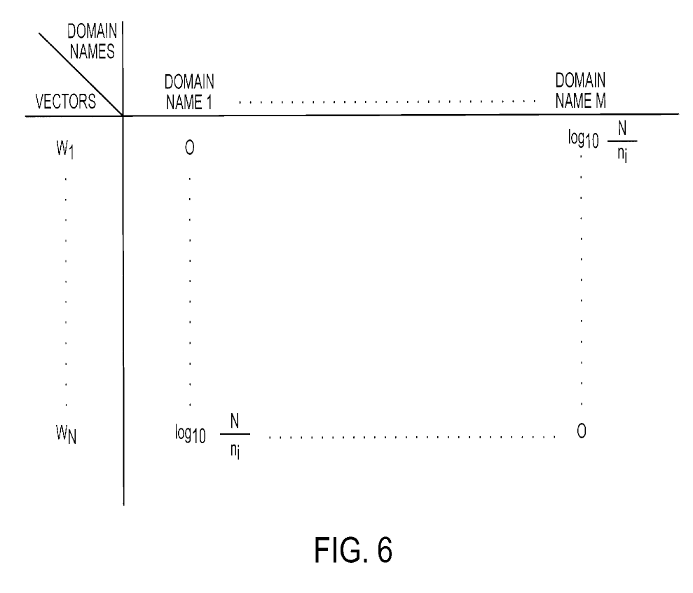

Moreover, prior to discarding the IP addresses of the clients, the entries in query logs can be rearranged into vectors, one for each client IP address. Thus, the IP addresses of the users are used to aggregate the domain names according to this exemplary embodiment. An example is discussed below with regard to FIGS. 6-8 solely for facilitating the understanding of this exemplary embodiment and not for limiting the present invention.

It is noted that at least two different representations of the domain names may be used in the following exemplary embodiments, (i) symbol sequences and (ii) real-valued vectors. The first representation is discussed in more detail in U.S. patent application Ser. No. ______, filed concurrently herewith, entitled “Probabilistic Association based Method and System for Determining Topical Relatedness of Domain Names” to M. Subotin and A. Sullivan (herein Subotin), the entire disclosure of which is incorporated here by reference.

The second representation is discussed next. A collection of vectors w₁ to w_{N}, where N is the number of client sessions as shown in FIG. 6, may include vectors of the same length with real-valued entries and may be supplied with coordinate labels drawn from a set of symbols. The vector representation may be used to describe the distributional similarity method. The exemplary embodiments describing the distributional similarity assume that two domains are related if they tend to appear in the same client session.

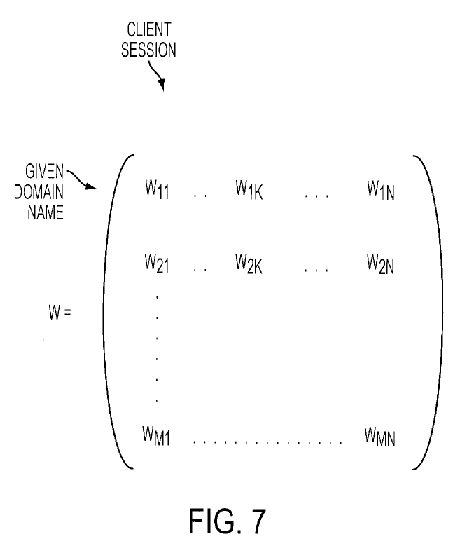

To formalize this assumption, a matrix representation W of client sessions is introduced and this matrix W is illustrated in FIG. 7. An arbitrary but fixed ordering for the client sessions is selected and an arbitrary but fixed ordering for the set of distinct observed domain names during each session is also selected. These two orderings are reflected in the columns and rows of matrix W. Each row w_{i*} of the matrix W is a vector wᵢ corresponding to a domain name, while each of its columns W_{*j} is a vector corresponding to a client session. The asterisk is a subscripted wildcard symbol denoting an entire row or column.

One way, according to an exemplary embodiment, to encode client session information in this matrix is to define wᵢⱼ=1, if domain name i appears at least once in client session j, and wᵢⱼ=0 otherwise, where wᵢⱼ is a numeric value that corresponds to row i and column j in matrix W. This encoding disregards both the order in which queries were received and specific non-zero counts of queries in the client session. Given a pair of domain name vectors wᵢ_{₁}_{*} and wᵢ_{₂}_{*}, the dot product between these vectors is equal to the number of client sessions in which queries for both domain names appeared, providing one measure of the domain names distributional similarity. However, this approach is computationally intensive and may require an extended period of time for computing the relatedness scores.

According to an exemplary embodiment, the entries wᵢⱼ may be multiplied by a factor of

$${log}_{10} \frac{N}{{n}_{i}}$$

(see FIG. 6), where nᵢ is the number of client sessions in which a query for domain name i appeared and N is the total number of client sessions. The role of this weighting factor is to downgrade the influence of domains requested by many clients, like google.com, since requests for these domains provide relatively little insight about interests of a user. Thus, matrix W may have elements

$${w}_{ij} = {log}_{10} \frac{N}{{n}_{i}} if$$

domain name i appears at least once in client session j, and wᵢⱼ=0 otherwise.

According to another exemplary embodiment a dimensionality reduction method may be applied to domain name vectors w_{i*} to counteract sparsity of the data. The sparsity is due to the larger amount of zeros present for each client session as a user may visit only ten domain names during a client session while the vector representing the client session may include millions of domain names. Thus, such a vector will have all positions zero except for the visited ten domain names. Given the fact that the number of available domain names might be in the order of millions, the size of vector wᵢ is large and the size of the matrix W is even larger.

Thus, according to an exemplary embodiment, dimensionality reduction may be performed by applying a dimensionality reduction method, for example, the truncated singular value decomposition (SVD) method applied to the domain name-session matrix W. For any M×N matrix W, the SVD (L. Trefethen and D. Bau, III., Numerical linear algebra, SIAM, 1997, the entire content of which is incorporated herein by reference) of W has the form:

W=UΣV^{T}, (1)

where U and V are two matrices that satisfy U^{T}U=V^{T}V=I (I is the identity matrix) and Σ is a matrix with non-negative entries σᵢ (called singular values) on the main diagonal and zeros elsewhere. The number of non-zero singular values is equal to the rank r of W and these non-zero singular values are arranged in the order of decreasing magnitude, so that σᵢ≧σⱼ whenever i<j. If k<r, the truncated SVD of rank k (Wₖ) may be obtained by replacing Σ in equation (1) by a matrix Σₖ, which differs from Σ only in that all but the k largest singular values are replaced by zeros. The form of this matrix Wₖ is

Wₖ=UΣₖV^{T} (2)

After constructing a new matrix WW^{T}, the entry in the i₁-th row and i₂-th column (the relatedness score) is equal to the dot product between weighted domain name vectors wᵢ₁* and wᵢ₂* discussed above. A pairwise similarity measure may be determined for domain name vectors from the truncated SVD by replacing WW^{T} with WₖWₖ^{T}, which has the expression:

WₖWₖ^{T}=(UΣₖV^{T})(UΣₖV^{T})^{T}=UΣₖV^{T}VΣₖU^{T}=UΣₖΣₖU^{T}=(UΣₖ)(UΣₖ)^{T}. (3)

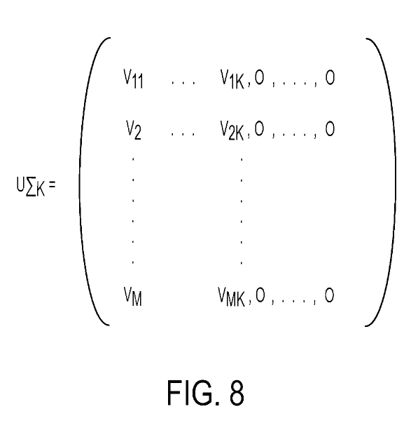

While the matrix Wₖ is in general dense, with each row possibly having as many non-zero entries as there are client sessions, the matrix UΣₖ, which is shown in FIG. 8, has non-zero entries only in its first k columns, which is advantageous from a calculation point of view because the number of domains tracked by the system may exceed one million and the number of client sessions is limited only by practical considerations. Thus, the WₖWₖ^{T} matrix may be expressed through dot products of k-dimensional vectors, where k may take, for example, a value of 200. The k-dimensional vectors vᵢ that correspond to the rows of the matrix UΣₖ are used for calculating the relatedness score.

According to an exemplary embodiment, the cosine of the angle between the vectors vᵢ of the UΣₖ matrix or, equivalently, the dot product of normalized vectors of the UΣₖ matrix pointing in the same direction (geometric direction of a vector) may be used to measure the relatedness score between a pair of vectors v₁ and v₂ (corresponding, in the exemplary embodiment described above, to the rows of the matrix UΣₖ). The dot product of the normalized vectors is:

$$sim ( {v}_{1} , {v}_{2} ) = \frac{{v}_{1}}{\vert {v}_{1} \vert} \cdot \frac{{v}_{2}}{\vert {v}_{2} \vert} , \qquad ( 4 )$$

where |.| is the Euclidean norm and the vectors vᵢ may correspond to rows of the matrix UΣₖ. The notation “sim” is used to indicate a generic similarity measure.

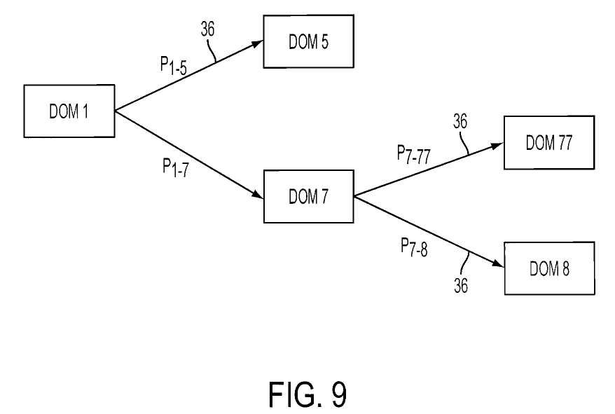

By calculating the novel distributional similarity based relatedness score for each pair of domains requested by the clients of a certain ISP, a path tree for each domain name may be constructed, as shown in FIG. 9. Each domain name DOMi (dᵢ) is connected to one or more other domain names via a corresponding direct path 36. Each path indicates possible sequences of domain names that are requested by a client. Each path may be associated with a probability (computed, for example, by dividing each relatedness score by the sum of scores associated with all connections between dᵢ and other domains) associated with traveling or navigating, for example, from domain DOM7 to DOM8. This probability p7-8, may be calculated by using the distributional similarity method. These calculated scores indicate, for example, for a generic user visiting domain DOM7, the most likely next domain to be visited based on the collective wisdom, i.e., the experience of the previous users which has been captured as data as described above. For example, if DOM8 is more likely to be related to DOM7 than DOM77, the estimated P₇₋₈ is likely to be higher than the estimated P₇₋₇₇. This is true because most users tend to exhibit similar behavior patterns.

These scores are calculated for pairs of domain names based on data captured and/or stored in the DNS. As discussed above, the DNS (described in patent application Ser. No. 11/550,975, entitled “Methods and Systems for node ranking based on DNS session data,” by A. Sullivan, assigned to Paxfire, the entire content of which is incorporated herein by reference) is a distributed Internet service typically used to associate domain names with corresponding Internet Protocol (IP) addresses. The DNS may serve as the “phone book” for the Internet by translating human-readable computer hostnames, e.g. www.paxfire.com, into IP addresses, e.g. 207.57.198.126. In response to a request to a DNS server, which is, e.g., sent by a DNS client as a result of a user clicking on a link in a browser, the DNS resolves a hostname to an IP address, which the client then uses to send an HTTP request to the domain that stores the requested page.

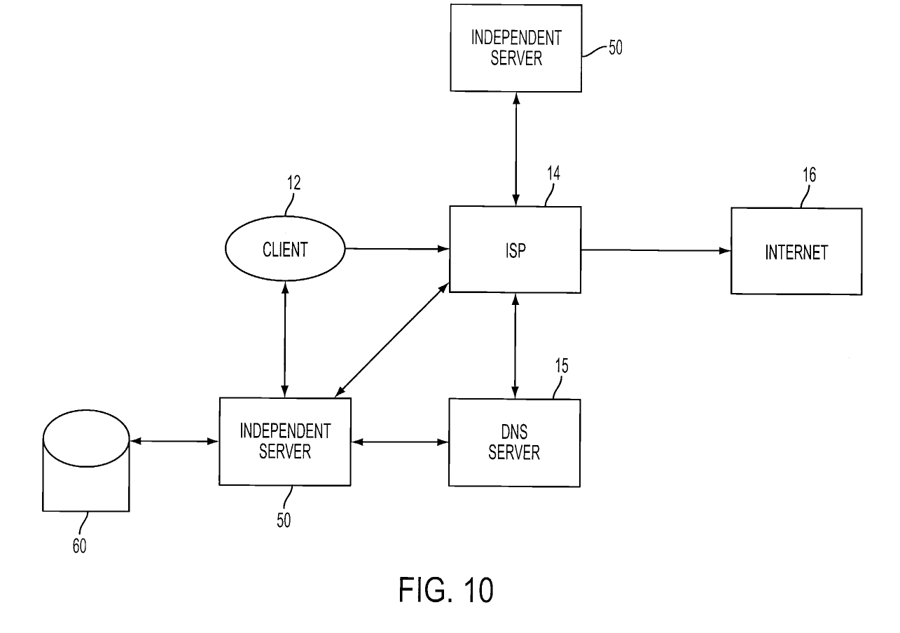

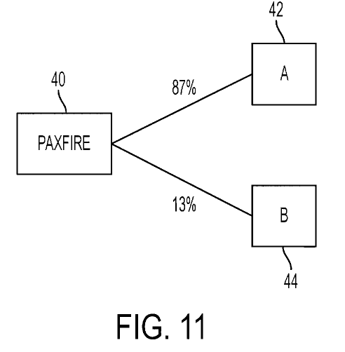

According to an exemplary embodiment, a method for calculating a distributional similarity based relatedness score which measures relatedness of pairs of domain names requested by clients may be implemented at the ISP 14 provider or at another location outside the ISP 14, for example, at an independent server 50 connected to the ISP 14 as shown in FIG. 10, at the client 12, and/or at the DNS server 15. More specifically, with regard to FIG. 11, assume that the client is visiting the domain named “Paxfire.com,” which provides specialized solutions for media interfaces. If the user intends to compare the products offered by Paxfire with similar products offered by the competition but the user does not know who the competition of Paxfire is, according to an exemplary embodiment the user may perform a domain name search (based on the above described method) instead of a keyword search to find out those domain names that are related to Paxfire.

If the user enters the name “Paxfire.com” in the search engine shown in FIG. 2, the search engine will communicate with an application located, for example, on the independent server 50 to search a database 60 (see FIG. 10), which stores the relatedness scores for the domain servers. The search on the database 60 identifies the domain names most related to Paxfire.com, which happen to be A.com and B.com in this particular example. For this example, assume that Paxfire provides media solutions to the service provider A and that the degree of association of Paxfire and A.com is 87% while the degree of association of Paxfire.com and B.com (a domain name belonging to a company that produces hardware for set top boxes) is only 13%. Thus, the distributional similarity method is able to identify that A.com is more related to Paxfire.com than any other domain name and also to identify other related businesses and their websites, e.g., site B.

In response to the query of the user, the independent server 50, based on the already calculated relatedness scores of Paxfire and other domain names, provides the user with the A and B's domain names (or other information pointing the user toward the A and B's domains, e.g., a complete URL or link to a URL associated with the A and B's domains) instead of any other domains, based on the high correlation between Paxfire and A and B.

In addition or alternately, the independent server 50 may provide the user with ads related to the A and/or B domains, i.e., ads associated with the most related domains to Paxfire. Alternatively, the independent server 50 may inform the A or B companies about the type of ad to be provided to the user and the companies may then provide the ad to the user. Thus, most of the users that visit Paxfire.com may automatically be provided with information associated with and/or a web site identifier of A and/or B when searching by domain name.

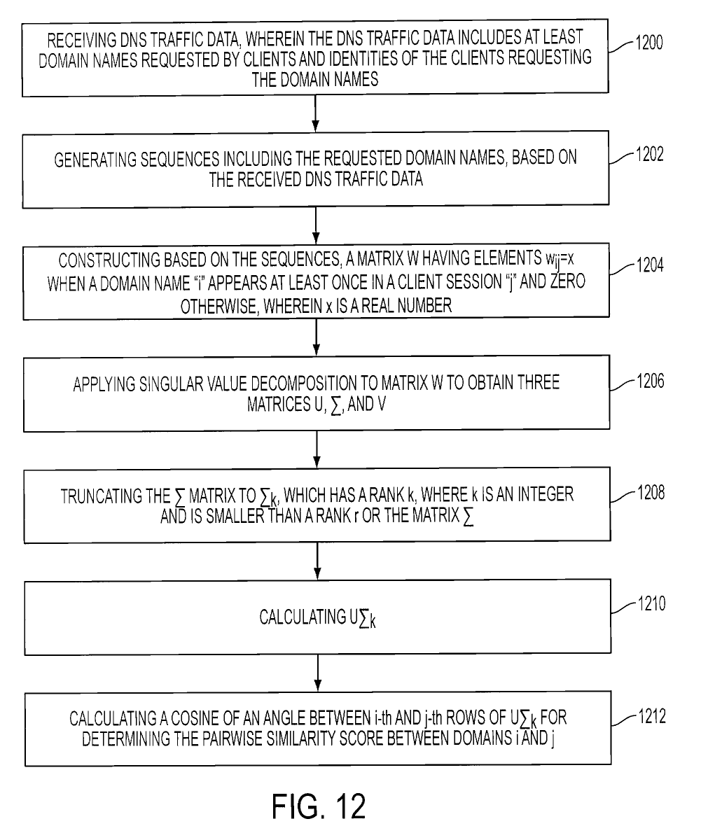

Thus, according to an exemplary embodiment shown in FIG. 12, there is a method for calculating a distributional similarity score which measures relatedness of pairs of domain names requested by clients, domain information being accessible via an Internet service provider, and the clients being connected to the Internet service provider. According to the method, there is a step 1200 of receiving DNS traffic data, wherein the DNS traffic data includes at least domain names requested by clients and identities of the clients requesting the domain names, a step 1202 of generating sequences including the requested domain names, based on the received DNS traffic data, a step 1204 of constructing based on the sequences, a matrix W having elements wᵢⱼ=x when a domain name “i” appears at least once in a client session “j” and zero otherwise, wherein x is a real number, a step 1206 of applying singular value decomposition to matrix W to obtain three matrices U, Σ, and V, a step 1208 of truncating the Σ matrix to Σₖ, which has a rank k, where k is an integer and is smaller than a rank r of the matrix Σ, a step 1210 of calculating UΣₖ; and a step 1212 of calculating a cosine of an angle between i-th and j-th rows of UΣₖ for determining the distributional similarity score between domains i and j.

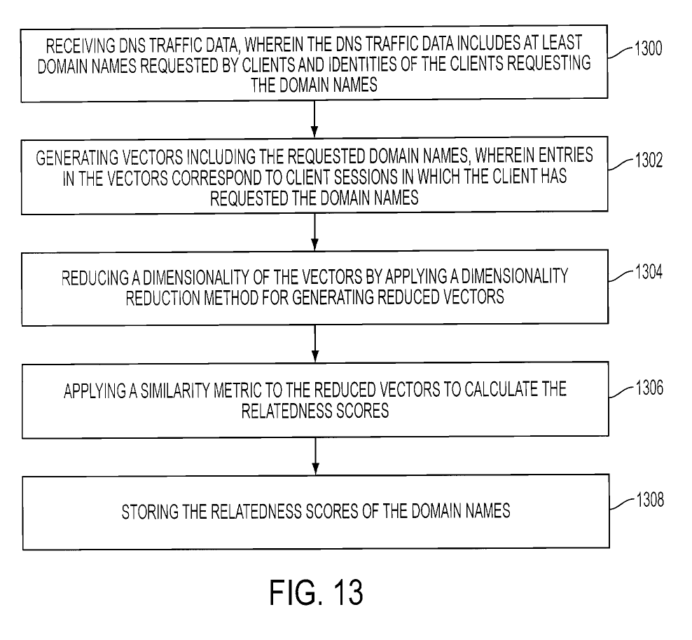

According to another exemplary embodiment shown in FIG. 13, there is a method for calculating relatedness scores of domain names, which are indicative of relatedness of pairs of domain names requested by clients. The method includes a step 1300 of receiving DNS traffic data, where the DNS traffic data includes at least domain names requested by the clients and identities of the clients requesting the domain names, a step 1302 of generating vectors including the requested domain names, where entries in the vectors correspond to client sessions in which the client has requested the domain names, a step 1304 of reducing dimensionality of the vectors by applying a dimensionality reduction method for generating reduced vectors, a step 1306 of applying a similarity metric to the reduced vectors to calculate the relatedness scores, and a step 1308 of storing the relatedness scores of the domain names.

According to an exemplary embodiment, the relatedness of a pair of domain names may be determined by combining scores determined with the probabilistic method, described in the above-incorporated by reference patent application, with scores determined with the distribution similarity method. The weights of such scores may be determined such that the final results fit the real relatedness of the considered domain names.

According to another exemplary embodiment, there may be cases when there is no need to generate the entire matrix WₖWₖ^{T}. Thus, after computing a truncated SVD of the weighted domain name-session matrix and storing the matrix UΣₖ, distributional similarity between pairs of domain name vectors may be computed on a per-need basis and further restricted to a subset of promising pairs of domain names, such as those which co-occur in at least one client session.

As will be recognized by one of ordinary skill in the art, algorithms for solving large-scale sparse truncated SVD problems efficiently are known. For example, the single vector Lanczos method applied to the eigensystem for the matrix W^{t}W may be used (see for example M. Berry, “Large Scale Sparse Singular Value Computations”, International Journal of Supercomputer Applications 6:1, (1992), pp. 13-49, the entire content of which is incorporated here by reference).

In another exemplary embodiment, other methods for reducing the dimensionality of domain name vectors may be used instead of truncated SVD. For example, other alternatives such as probabilistic latent semantic indexing (T. Hofmann, Probabilistic Latent Semantic Indexing, Proceedings of the Twenty-Second Annual International SIGIR Conference on Research and Development in Information Retrieval (SIGIR-99), 1999, the entire content of which is incorporated herein by reference) and latent Dirichlet allocation (Blei et al., January 2003, “Latent Dirichlet allocation”, Journal of Machine Learning Research 3: pp. 993-1022, the entire content of which is incorporated herein by reference) may be used to achieve better results in formally similar applications but may incur greater computational costs.

According to an exemplary embodiment, once matrix W shown in FIG. 7 has been formed, the real IP addresses of all the users may be removed, thus protecting the confidentiality of the users. Therefore, the IP addresses of the users have been used only to properly generate the vectors w and the real addresses of the users cannot be traced in the generated matrix W. This enables the matrix W to be transmitted from a secure server to another location for processing without such security concerns.

Optional heuristics may be used in the process of generating vectors w and matrix W. For example, the queries may be processed to delete some of their sub-domain portions, i.e., the query graphics8.nytimes.com may be converted to nytimes.com. The queries not appearing in a certain list (e.g., a list of domains reflecting high popularity rankings) or appearing in a certain list (e.g., a list of domains known to contain sexually explicit material) may be filtered out.

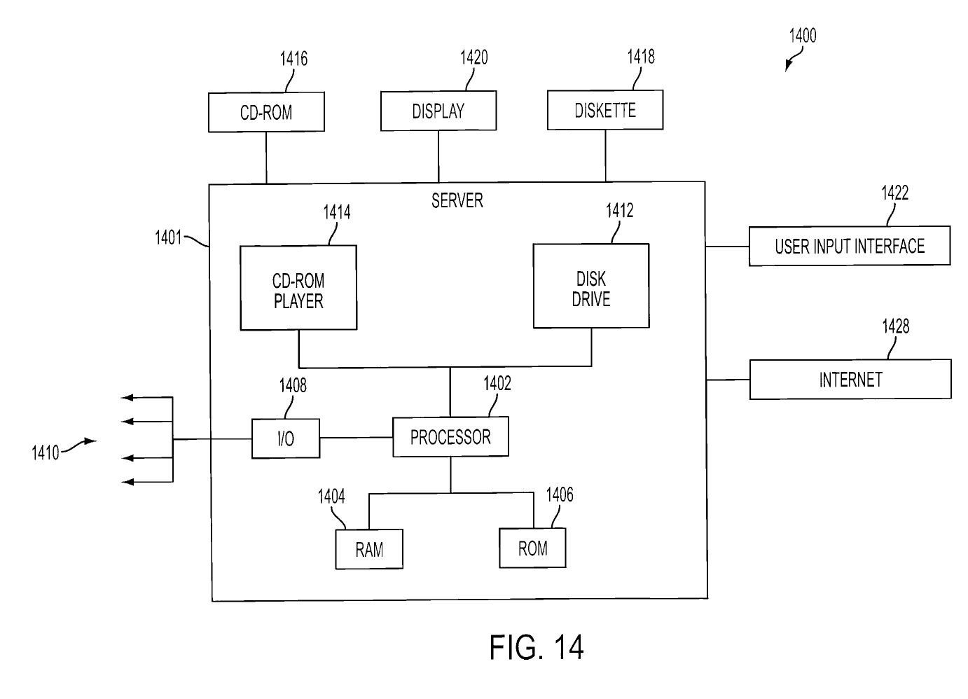

For purposes of illustration and not of limitation, an example of a representative computing system capable of carrying out operations in accordance with the exemplary embodiments is illustrated in FIG. 14. It should be recognized, however, that the principles of the present exemplary embodiments are equally applicable to standard computing systems. Hardware, firmware, software or a combination thereof may be used to perform the various steps and operations described herein.

The exemplary computing arrangement 1400 suitable for performing the activities described in the exemplary embodiments may include a server 1401 with appropriate configuration and access. Such a server 1401 may include a central processor (CPU) 1402 coupled to a random access memory (RAM) 1404 and to a read-only memory (ROM) 1406. The ROM 1406 may also be implemented as other types of storage media to store programs, such as a programmable ROM (PROM), an erasable PROM (EPROM), etc. The processor 1402 may communicate with other internal and external components through input/output (I/O) circuitry 1408 and bussing 1410, to provide control signals and the like. The processor 1402 carries out a variety of functions as is known in the art, as dictated by software and/or firmware instructions.

The server 1401 may also include one or more data storage devices, including hard and floppy disk drives 1412, CD-ROM drives 1414, and other hardware capable of reading and/or storing information such as DVD, etc. In one embodiment, software for carrying out the above discussed steps may be stored and distributed on a CD-ROM 1416, diskette 1418 or other form of media capable of portably storing information. These storage media may be inserted into, and read by, devices such as the CD-ROM drive 1414, the disk drive 1412, etc. The server 1401 may be coupled to a display 1420, which may be any type of known display or presentation screen, such as LCD displays, plasma display, cathode ray tubes (CRT), etc. A user input interface 1422 is provided, including one or more user interface mechanisms such as a mouse, keyboard, microphone, touch pad, touch screen, voice-recognition system, etc.

The server 1401 may be coupled to other computing devices, such as landline and/or wireless terminals and associated watcher applications, via a network. The server may be part of a larger network configuration as in a global area network (GAN) such as the Internet 1428, which allows ultimate connection to the various landline and/or mobile client devices.

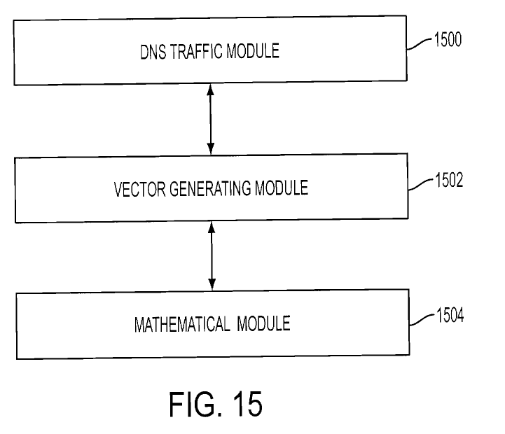

The processor 1402 of the server 1401 may be programmed to generate specific modules for implementing the methods illustrated in FIGS. 12 and/or 13. According to an exemplary embodiment shown in FIG. 15, the modules may include a DNS traffic module 1500 for receiving DNS data, a vector generating module 1502 for generating vectors including the requested domain names, and a mathematical module 1506 for performing matrix calculations or other mathematical functions as discussed in the exemplary embodiments.

The disclosed exemplary embodiments provide a server, a method and a computer program product for identifying domain names that are related to each other. It should be understood that this description is not intended to limit the invention. On the contrary, the exemplary embodiments are intended to cover alternatives, modifications and equivalents, which are included in the spirit and scope of the invention as defined by the appended claims. For example, according to exemplary embodiments, a search engine's graphical user interface can provide options for the user input to be considered as a keyword (i.e., perform a traditional keyword search using the input(s)), a domain name (i.e., perform a domain name relatedness search using the input(s)), or both (i.e., perform both a traditional keyword search using the inputs and a domain name relatedness search using the input(s) and combine or select results from both searches to be displayed to the user). Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for calculating relatedness scores of domain names, which are indicative of relatedness of pairs of domain names requested by clients, the method comprising:
receiving domain name system (DNS) traffic data, wherein the DNS traffic data includes at least domain names requested by the clients and identities of the clients requesting the domain names;
generating, based on the identities of the clients, vectors including the requested domain names, wherein entries in the vectors correspond to client sessions in which the client has requested the domain names;
reducing a dimensionality of the vectors by applying a dimensionality reduction method for generating reduced vectors;
applying a similarity metric to the reduced vectors to calculate the relatedness scores; and
storing the relatedness scores of the domain names.

2. The method of claim 1, further comprising:
constructing, based on the vectors, a matrix W having elements wᵢⱼ when a domain name “i” appears at least once in a client session “j” and zero otherwise, wherein wᵢⱼ is a real number.

3. The method of claim 2, further comprising:
applying singular value decomposition to matrix W to obtain three matrices U, Σ, and V.

4. The method of claim 3, wherein the step of reducing further comprises:
truncating the Σ matrix to Σₖ, which has a rank k, where k is an integer and is smaller than a rank r of the matrix Σ; and
calculating UΣₖ.

5. The method of claim 4, further comprising:
identifying rows of the calculated UΣₖ matrix as the reduced vectors.

6. The method of claim 5, wherein the applying a similarity metric step further comprises:
calculating a cosine of an angle between i-th and j-th rows of UΣₖ for determining the relatedness score between domains i and j.

7. The method of claim 1, further comprising:
calculating the relatedness score for all pairs of available domain names in an Internet service provider; and
generating a database that stores the calculated relatedness scores for the available domain names.

8. A server for calculating relatedness scores of domain names, which are indicative of relatedness of pairs of domain names requested by clients, the server comprising:
an input/output interface configured to receive domain name system (DNS) traffic data, wherein the DNS traffic data includes at least domain names requested by the clients and identities of the clients requesting the domain names;
a processor connected to the input/output interface and configured to,
generate, based on the identities of the clients, vectors including the requested domain names, wherein entries in the vectors correspond to client sessions in which the client has requested the domain names,
reduce a dimensionality of the vectors by applying a dimensionality reduction method for generating reduced vectors, and
apply a similarity metric to the reduced vectors to calculate the relatedness scores; and
a memory connected to the processor and configured to store the relatedness scores of the domain names.

9. The server of claim 8, wherein the processor is further configured to,
construct, based on the vectors, a matrix W having non-zero entries wᵢⱼ when a domain name “i” appears at least once in a client session “j” and zero entries otherwise, wherein wᵢⱼ is a real number.

10. The server of claim 9, wherein the processor is further configured to,
apply singular value decomposition to matrix W to obtain three matrices U, Σ, and V.

11. The server of claim 10, wherein the processor is further configured to,
truncate the Σ matrix to Σₖ, which has a rank k, where k is an integer and is smaller than a rank r of the matrix Σ; and
calculate UΣₖ.

12. The server of claim 11, wherein the processor is further configured to,
identify rows of the calculated UΣₖ matrix as the reduced vectors.

13. The server of claim 12, wherein the processor is further configured to
calculate a cosine of an angle between i-th and j-th rows of UΣₖ for determining the relatedness score between domains i and j.

14. The server of claim 8, wherein the processor is further configured to
calculate the relatedness score for all pairs of available domain names in an Internet service provider; and
generate a database that stores the calculated relatedness scores for the available domain names.

15. A computer readable medium including computer executable instructions, wherein the instructions, when executed, implement a method for calculating relatedness scores of domain names, which are indicative of relatedness of pairs of domain names requested by clients, the method comprising:
providing a system comprising distinct software modules, wherein the distinct software modules comprise a domain name system (DNS) traffic module, a vector generating module, and a mathematical module;
receiving DNS traffic data via the DNS traffic module, wherein the DNS traffic data includes at least domain names requested by the clients and identities of the clients requesting the domain names;
generating in the vector generating module, based on the identities of the clients, vectors including the requested domain names, wherein entries in the vectors correspond to client sessions in which the client has requested the domain names;
reducing in the mathematical module dimensionality of the vectors by applying a dimensionality reduction method for generating reduced vectors;
applying a similarity metric to the reduced vectors to calculate the relatedness scores; and
storing the relatedness scores of the domain names.

16. The medium of claim 15, further comprising:
constructing, based on the vectors, a matrix W having non-zero entries wᵢⱼ when a domain name “i” appears at least once in a client session “j” and zero entries otherwise, wherein wᵢⱼ is a real number.

17. The medium of claim 16, further comprising:
applying singular value decomposition to matrix W to obtain three matrices U, Σ, and V.

18. The medium of claim 17, wherein the step of reducing further comprises:
truncating the Σ matrix to Σₖ, which has a rank k, where k is an integer and is smaller than a rank r of the matrix Σ; and
calculating UΣₖ.

19. The medium of claim 18, further comprising:
identifying rows of the calculated UΣₖ matrix as the reduced vectors.

20. The medium of claim 19, wherein the processor is further configured to,
calculate a cosine of an angle between i-th and j-th rows of UΣₖ for determining the relatedness score between domains i and j.
